(19) United States
(12) Patent Application Publication
(10) Pub. No.: US 2016/0351926 A1
(43) Pub. Date: Dec. 1, 2016

(54) ELECTROLYTE CONVEYANCE DEVICE FOR FLOW BATTERY

(71) Applicants: FU-TZU HSU, Taipei City (TW); Chieh-Sen Tu, New Taipei City (TW)

(72) Inventors: FU-TZU HSU, Taipei City (TW); Chieh-Sen Tu, New Taipei City (TW)

(21) Appl. No.: 14/721,674

(22) Filed: May 26, 2015

(51) Int. Cl. H01M 8/04; H01M 8/20; H01M 8/18

(52) U.S. Cl. CPC H01M 8/04276; H01M 8/188; H01M 8/20

(57) ABSTRACT

An electrolyte conveyance device for flow battery includes a first permanent magnet direct current (PMDC) motor, a second PMDC motor, a power-output shaft, a first screw rod conveyance unit, and a second screw rod conveyance unit. The power-output shaft is a common power-output shaft of the first and second PMDC motors for driving the first and second screw rod conveyance units to operate at the same time, so as to convey a positive and a negative electrolyte, respectively, from positive and negative electrolyte tanks to a battery cell of the flow battery. The first and second PMDC motors serve as filters on a charging and a discharging circuit of the flow battery, and are driven by the electrical energy of removed surges to operate for conveying the electrolytes without consuming the electrical energy stored in the flow battery.

### FIELD OF THE INVENTION

The present invention relates to an electrolyte conveyance device for flow battery, in which two permanent magnet direct current (PMDC) motors are used as filters on a charging and a discharging circuit of the flow battery and the PMDC motors are driven by the electrical energy of removed surges to operate without consuming the electrical energy stored in the flow battery.

### BACKGROUND OF THE INVENTION

A flow battery has many advantages, such as long cycle life, large-scale energy storage and high security in use, and has been adopted by many developed countries in the world as the most important target in planning their energy storage technology development. Among others, vanadium redox flow battery is currently a representative example of flow batteries. Due to its many advantages, a vanadium battery energy storage system has immeasurable development potential in the future energy storage industrial field and even possibly changes the future energy source configurations.

FIG. 1 shows the structure of a vanadium redox flow battery, which includes a battery cell 10, a positive electrolyte tank 11, a negative electrolyte tank 12, a positive electrolyte flow-out pipeline 111, a positive electrolyte flow-in pipeline 112, a negative electrolyte flow-out pipeline 121, and a negative electrolyte flow-in pipeline 122. The battery cell 10 internally includes a positive electrode plate 101, a negative electrode plate 102, and a proton exchange membrane 103 located between the positive and the negative electrode plate 101, 102. The positive electrolyte flow-out pipeline 111 has a liquid pump 113 connected thereto for pumping a positive electrolyte 114 stored in the positive electrolyte tank 11 into the battery cell 10. The negative electrolyte flow-out pipeline 121 has another liquid pump 123 connected thereto for pumping a negative electrolyte 124 stored in the negative electrolyte tank 12 into the battery cell 10.

Either in a charging or a discharging state, the vanadium redox flow battery must always have the positive electrolyte 114 and the negative electrolyte 124 continuously conveyed to the battery cell 10. Thus, the liquid pump 113 connected to the positive electrolyte flow-out pipeline 111 and the liquid pump 123 connected to the negative electrolyte flow-out pipeline 121 have to operate continuously. The liquid pumps 113, 123 in operation will consume the energy stored in the battery cell 10 to thereby reduce the energy storage efficiency of the vanadium redox flow battery. In FIG. 1, reference numeral 13 denotes an electrical energy generating device, reference numeral 14 denotes a load, and reference numerals 15, 16 denote two filters.

### SUMMARY OF THE INVENTION

A primary object of the present invention is to provide an electrolyte conveyance device for flow battery, in which two permanent magnet direct current (PMDC) motors are used as filters on a charging and a discharging circuit of the flow battery, and the PMDC motors are driven by the electrical energy of removed surges to operate, forming a power source for conveying electrolytes without consuming the electrical energy stored in the flow battery.

To achieve the above and other objects, the electrolyte conveyance device for flow battery provided according to the present invention includes a first PMDC motor, a second PMDC motor, a power-output shaft, a first screw rod conveyance unit and a second screw rod conveyance unit; and the flow battery includes a battery cell, a positive electrolyte tank, a negative electrolyte tank, a positive electrolyte flow-out pipeline, and a negative electrolyte flow-out pipeline.

The first screw rod conveyance unit is arranged on the positive electrolyte flow-out pipeline of the flow battery mainly for conveying a positive electrolyte to the battery cell. The second screw rod conveyance unit is arranged on the negative electrolyte flow-out pipeline of the flow battery mainly for conveying a negative electrolyte to the battery cell.

The power-output shaft is a common power-output shaft of the first and the second PMDC motor for driving the first and the second screw rod conveyance unit to operate at the same time, so as to convey the positive and the negative electrolyte to the battery cell of the flow battery.

The first screw rod conveyance unit includes a first L-shaped pipe and a first screw rod having a plurality of screw threads formed thereon. The first L-shaped pipe is communicable with the positive electrolyte tank and the battery cell at the same time. When the first screw rod is driven to rotate, the positive electrolyte is conveyed to the battery cell of the flow battery.

The second screw rod conveyance unit includes a second L-shaped pipe and a second screw rod having a plurality of screw threads formed thereon. The second L-shaped pipe is communicable with the negative electrolyte tank and the battery cell at the same time. When the second screw rod is driven to rotate, the negative electrolyte is conveyed to the battery cell of the flow battery.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows the structure of a flow battery;

FIG. 2 schematically shows the structure of a flow battery, with which an electrolyte conveyance device according to the present invention is used;

FIG. 3 is a schematic circuit diagram of the flow battery of FIG. 2 that uses the electrolyte conveyance device of the present invention;

FIG. 4 is a partially sectional view showing the electrolyte conveyance device for flow battery according to a preferred embodiment of the present invention; and

FIG. 5 is a sectional view showing the electrolyte conveyance device for flow battery according to the present invention can also be used along with conventional liquid pumps to convey the electrolytes.

### DETAILED DESCRIPTION OF THE PREFERRED EMBODIMENTS

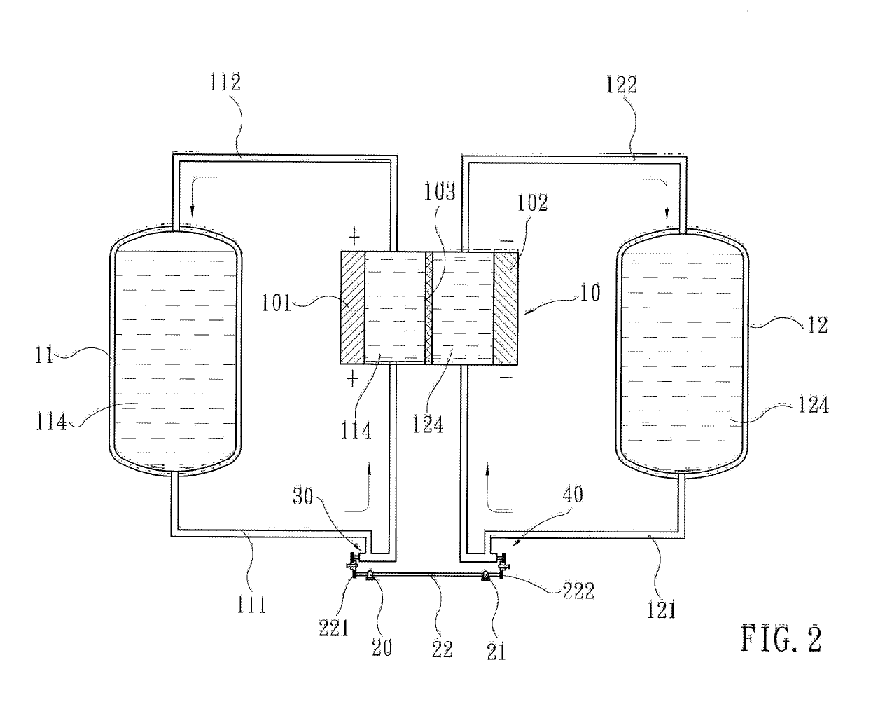

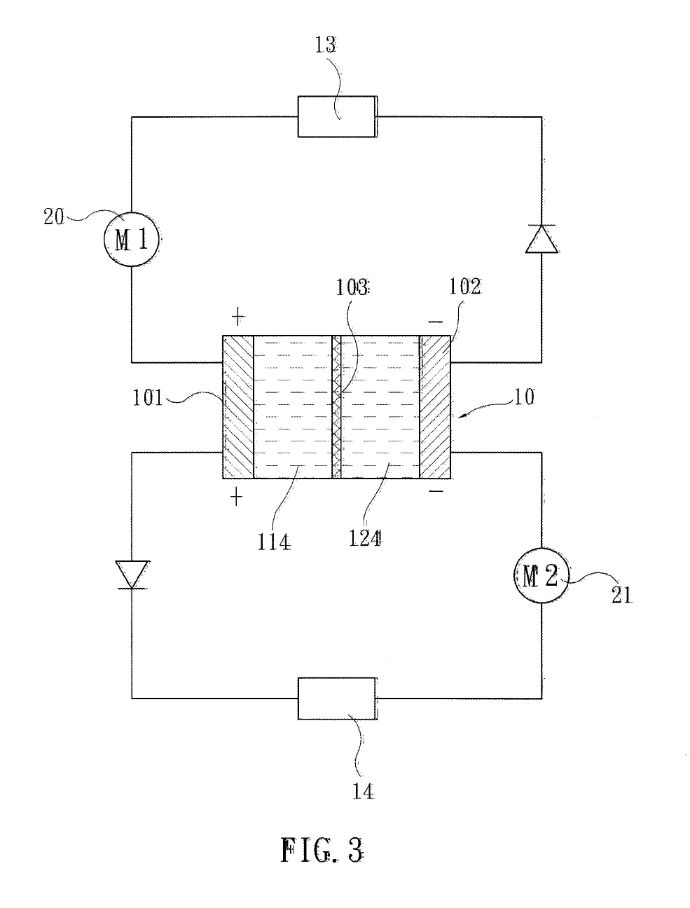

Please refer to FIGS. 2 and 3. A flow battery, with which an electrolyte conveyance device according to the present invention is used, includes a battery cell 10, a positive electrolyte tank 11, a negative electrolyte tank 12, a positive electrolyte flow-out pipeline 111, a positive electrolyte flow-in pipeline 112, a negative electrolyte flow-out pipeline 121, and a negative electrolyte flow-in pipeline 122.

The battery cell 10 is connected to a charging circuit and a discharging circuit of the flow battery. The charging circuit includes an electrical energy generating device 13, which can be a renewable energy generating device, such as a solar generator and a wind turbine. Electrical energy stored in the battery cell 10 can be discharged to a load 14 via the discharging circuit. The battery cell 10 internally includes a positive electrode plate 101, a negative electrode plate 102, and a proton exchange membrane 103 disposed between the positive and the negative electrode plate 101, 102.

The flow battery can be a vanadium redox flow battery, which can also be briefly referred to as vanadium redox battery. Either in a charging or a discharging state, the flow battery must always have positive electrolyte 114 and negative electrolyte 124 continuously conveyed from the positive and the negative electrolyte tank 11, 12, respectively, to the battery cell 10.

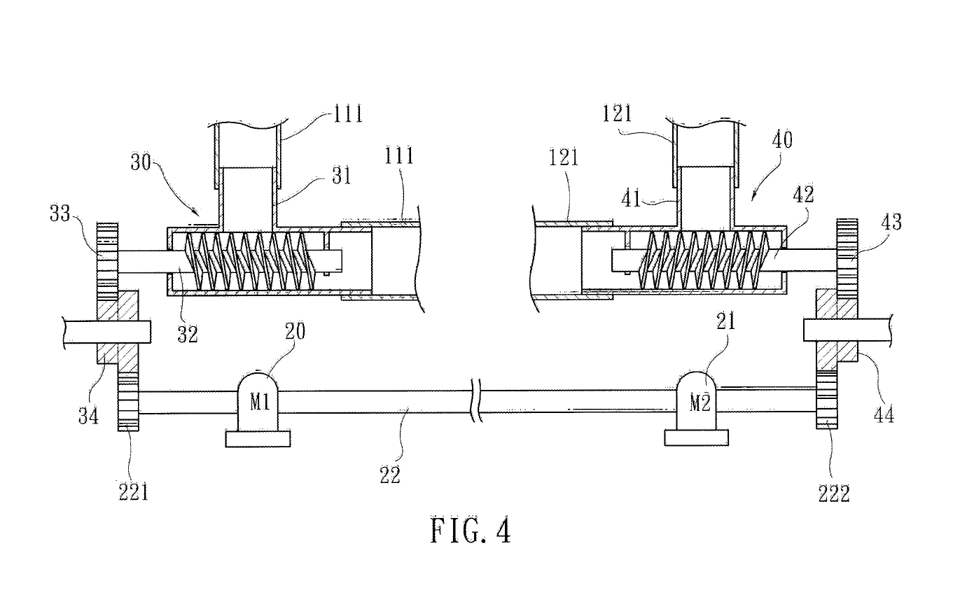

As can be seen in FIGS. 2, 3 and 4, the electrolyte conveyance device for flow battery according to a preferred embodiment of the present invention includes a first permanent magnet direct current (PMDC) motor 20, a second PMDC motor 21, a power-output shaft 22, a first screw rod conveyance unit 30, and a second screw rod conveyance unit 40. The power-output shaft 22 is a common power-output shaft of the first and the second PMDC motor 20, 21 to drive the first and the second screw rod conveyance unit 30, 40 to operate simultaneously. The first and second screw rod conveyance units 30, 40 in operation convey the positive electrolyte 114 and the negative electrolyte 124, respectively, to the battery cell 10.

The first PMDC motor 20 is connected to the charging circuit of the flow battery to serve as a filter for removing surges and accordingly, ensuring the safe use of the charging circuit. The first PMDC motor 20 uses the electrical energy of the removed surges as its power source for operation. The second PMDC motor 21 is connected to the discharging circuit of the flow battery to serve as a filter for removing surges and accordingly, ensuring the safe use of the discharging circuit. The second PMDC motor 21 uses the electrical energy of the removed surges as its power source for operation. Thus, when the first and second PMDC motors 20, 21 operate, they are not powered by the battery cell 10 and do not consume the electrical energy stored in the battery cell 10, enabling the battery cell 10 to have increased electrical energy storage efficiency.

The first screw rod conveyance unit 30 is arranged on the positive electrolyte flow-out pipeline 111 of the flow battery, and is driven by the power-output shaft 22 to operate. The first screw rod conveyance unit 30 includes a first L-shaped pipe 31 and a first screw rod 32 having a plurality of screw threads formed thereon. The first L-shaped pipe 31 has a vertical open end communicable with the positive electrolyte tank 11 and a horizontal open end communicable with the battery cell 10. The first screw rod 32 is horizontally disposed in the first L-shaped pipe 31 and has an outer end horizontally extended through a wall of the first L-shaped pipe 31 to fixedly connect to a first gear 33. When the first screw rod 32 is driven to rotate, it conveys the positive electrolyte 114 to the battery cell 10 of the flow battery.

The second screw rod conveyance unit 40 is arranged on the negative electrolyte flow-out pipeline 121 of the flow battery, and is driven by the power-output shaft 22 to operate. The second screw rod conveyance unit 40 includes a second L-shaped pipe 41 and a second screw rod 42 having a plurality of screw threads formed thereon. The second L-shaped pipe 41 has a vertical open end communicable with the negative electrolyte tank 12 and a horizontal open end communicable with the battery cell 10. The second screw rod 42 is horizontally disposed in the second L-shaped pipe 41 and has an outer end horizontally extended through a wall of the second L-shaped pipe 41 to fixedly connect to a third gear 43. When the second screw rod 42 is driven to rotate, it conveys the negative electrolyte 124 to the battery cell 10 of the flow battery.

An end of the power-output shaft 22 adjacent to the first PMDC motor 20 has a second gear 221 fixedly connected thereto, and another end of the power-out shaft 22 adjacent to the second PMDC motor 21 has a fourth gear 222 fixedly connected thereto. A first reduction gear 34 is connected to between the second gear 221 and the first gear 33 fixedly connected to the outer end of the first screw rod 32, such that the second gear 221 can drive the first gear 33 to rotate. Similarly, a second reduction gear 44 is connected to between the fourth gear 222 and the third gear 43 fixedly connected to the outer end of the second screw rod 42, such that the fourth gear 222 can drive the third gear 43 to rotate. When one or both of the first PMDC motor 20 and the second PMDC motor 21 operate, the power-output shaft 22 is rotated and drives the first screw rod 32 and the second screw rod 42 to rotate at the same time, so that the positive electrolyte 114 and the negative electrolyte 124 are conveyed to the battery cell 10.

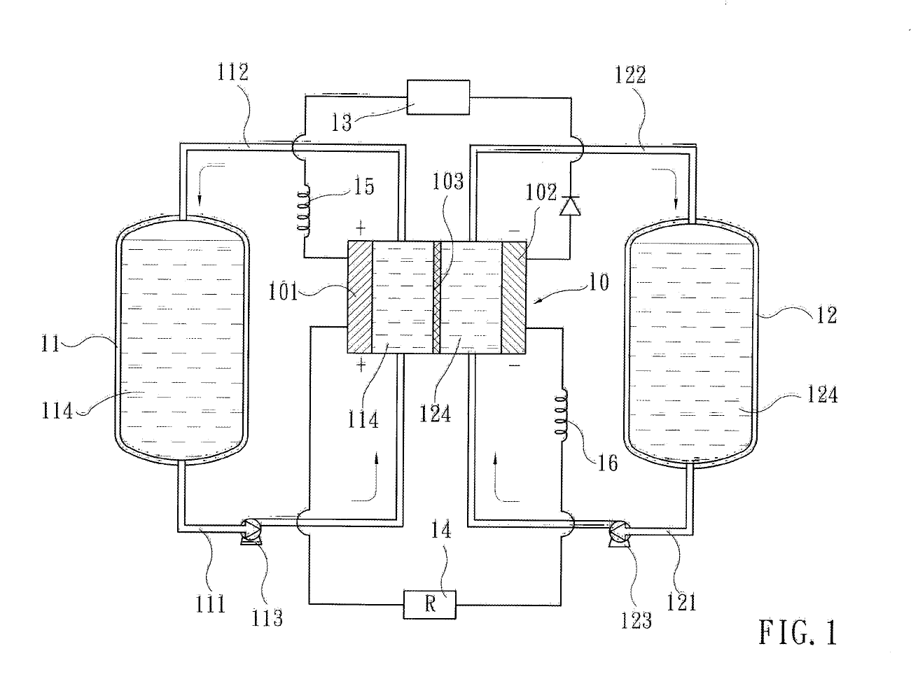

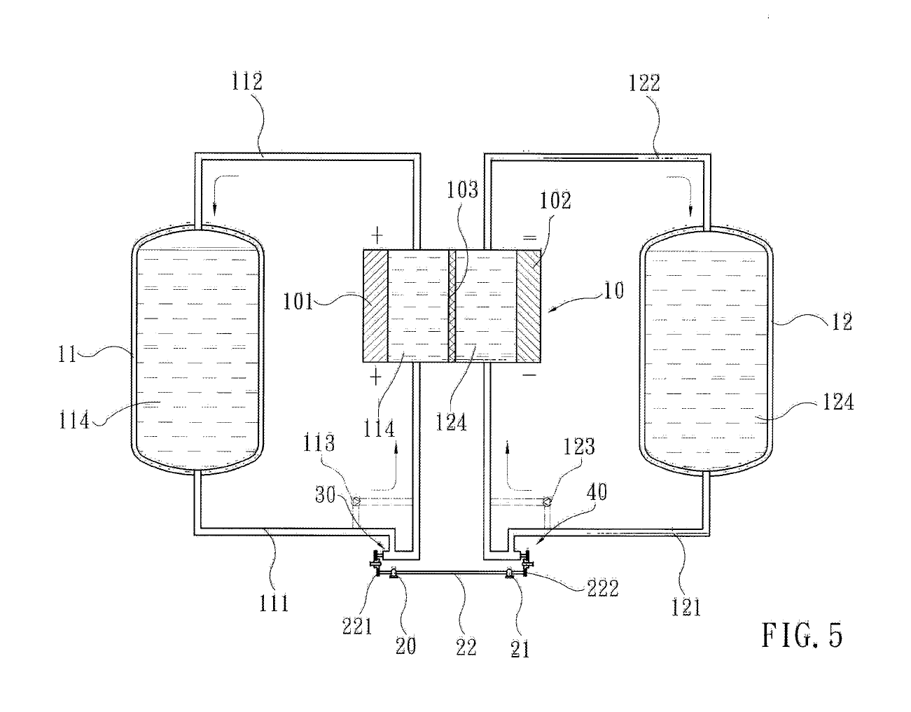

With the electrolyte conveyance device of the present invention connected to the flow battery, it is able to ensure normal conveyance of the positive electrolyte 114 and the negative electrolyte 124 to the battery cell 10. However, to further ensure an uninterrupted operation of the flow battery, the conventional liquid pumps 113, 123 shown in FIG. 1 can still be included in the flow battery to convey the positive and the negative electrolyte 114, 124. Please refer to FIG. 5. A branch pipe can be connected to each of the positive electrolyte flow-out pipeline 111 and the negative electrolyte flow-out pipeline 121 to bypass the first and the second PMDC motor 20, 21, respectively. And, the liquid pumps 113, 123 are separately connected to the branch pipes for conveying the positive and the negative electrolyte 114, 124, respectively. However, in practical use of the flow battery, the liquid pumps 113, 123 are usually standby arrangements only.

In brief, in the electrolyte conveyance device for flow battery according to the present invention, the first and/or the second PMDC motor 20, 21 is electrically driven to operate by the electrical energy of the surges that must be removed from the battery circuit and therefore does not consume the electrical energy stored in the battery cell 10, naturally enabling the flow battery to have increased electrical energy storage efficiency.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An electrolyte conveyance device for flow battery, the flow battery including a battery cell, a positive electrolyte tank having a positive electrolyte stored therein, a negative electrolyte tank having a negative electrolyte stored therein, a positive electrolyte flow-out pipeline, and a negative electrolyte flow-out pipeline; the electrolyte conveyance device comprising:
a first permanent magnet direct current (PMDC) motor serving as a filter on a charging circuit of the flow battery and being powered by electrical energy of removed surges to operate;
a second PMDC motor serving as a filter on a discharging circuit of the flow battery and being powered by electrical energy of removed surges to operate;
a power-output shaft being a common power-output shaft of the first and the second PMDC motor;
a first screw rod conveyance unit being arranged on the positive electrolyte flow-out pipeline of the flow battery and driven by the power-output shaft to operate; and the first screw rod conveyance unit including a first screw rod having a plurality of screw threads formed thereon, such that the first screw rod driven by the first PMDC motor to rotate functions to convey the positive electrolyte to the battery cell of the flow battery; and
a second screw rod conveyance unit being arranged on the negative electrolyte flow-out pipeline of the flow battery and driven by the power-output shaft to operate; and the second screw rod conveyance unit including a second screw rod having a plurality of screw threads formed thereon, such that the second screw rod driven by the second PMDC motor to rotate functions to convey the negative electrolyte to the battery cell of the flow battery.

2. The electrolyte conveyance device for flow battery as claimed in claim 1, wherein the first screw rod conveyance unit further includes a first L-shaped pipe; the first L-shaped pipe having a vertical open end communicable with the positive electrolyte tank and a horizontal open end communicable with the battery cell; and the first screw rod being horizontally disposed in the first L-shaped pipe and having an outer end horizontally extended through a wall of the first L-shaped pipe to fixedly connect to a first gear.

3. The electrolyte conveyance device for flow battery as claimed in claim 2, wherein an end of the power-output shaft adjacent to the first PMDC motor has a second gear fixedly connected thereto for driving the first gear on the outer end of the first screw rod to rotate.

4. The electrolyte conveyance device for flow battery as claimed in claim 3, wherein the second gear and the first gear have a first reduction gear connected to between them.

5. The electrolyte conveyance device for flow battery as claimed in claim 1, wherein the second screw rod conveyance unit further includes a second L-shaped pipe; the second L-shaped pipe having a vertical open end communicable with the negative electrolyte tank and a horizontal open end communicable with the battery cell; and the second screw rod being horizontally disposed in the second L-shaped pipe and having an outer end horizontally extended through a wall of the second L-shaped pipe to fixedly connect to a third gear.

6. The electrolyte conveyance device for flow battery as claimed in claim 5, wherein another opposite end of the power-out shaft adjacent to the second PMDC motor has a fourth gear fixedly connected thereto for driving the third gear on the outer end of the second screw rod to rotate.

7. The electrolyte conveyance device for flow battery as claimed in claim 6, wherein the fourth gear and the third gear have a second reduction gear connected to between them.

8. The electrolyte conveyance device for flow battery as claimed in claim 1, wherein the flow battery is a vanadium redox flow battery.
